(19) United States
(12) Patent Application Publication
(10) Pub. No.: US 2026/0054835 A1
(43) Pub. Date: Feb. 26, 2026

(54) MODULAR PYLON ASSEMBLY AND ASSOCIATED SYSTEMS AND METHODS

(71) Applicant: The Boeing Company, Arlington, VA (US)

(72) Inventor: Tristin T. Lam, Edmond, OK (US)

(21) Appl. No.: 18/812,355

(22) Filed: Aug. 22, 2024

(51) Int. Cl. B64D 1/06

(52) U.S. Cl. CPC B64D 1/06

(57) ABSTRACT

Disclosed herein is a modular pylon assembly for an aircraft. The pylon assembly includes a core module with an inboard side and an outboard side, each equipped with multiple sets of carriage-attachment elements. A forward post assembly and an aft post assembly extend from the core module and are removably mountable to the aircraft. The pylon assembly also includes a carriage module that can be removably attached to either the inboard side or the outboard side of the core module, using a selected set of carriage-attachment elements. Additionally, a suspension rack is mounted to the carriage module to support a payload. The core module is reconfiguration for left side or right side attachment to the aircraft.

### FIELD

This disclosure relates generally to a pylon assembly, and more particularly to a pylon assembly with modular functionality.

### BACKGROUND

In the aviation industry, the carriage of external payloads, such as ordnance (e.g., weapons), fuel tanks, sensor pods, and camera pods, is typically accomplished using surface-mounted pylons. A pylon is a structural support that attaches external payloads to the aircraft's structure, providing secure mounting points while maintaining aerodynamic efficiency. Commonly, the size, weight, and type of payload that can be carried by conventional pylons is limited due to their capabilities and restrictions. Additionally, conventional pylons often restrict the operational capabilities of the aircraft by limiting the ability of weapons bay doors to fully open and introducing proximity constraints for certain payloads, which further complicates the carriage of payloads.

### SUMMARY

The subject matter of the present application has been developed in response to the present state of the art, and in particular, in response to the shortcomings of conventional pylons, that have not yet been fully solved by currently available techniques. Accordingly, the subject matter of the present application has been developed to provide a pylon assembly and associated systems and methods that overcome at least some of the above-mentioned shortcomings of prior art techniques.

The following is a non-exhaustive list of examples, which may or may not be claimed, of the subject matter, disclosed herein.

Disclosed herein is a pylon assembly for an aircraft including a core module having an inboard side with first sets of carriage-attachment elements and an outboard side, opposite of the inboard side and with second sets of carriage-attachment elements. A forward post assembly extends from a forward portion of the core module and an aft post assembly extends from an aft portion of the core module. The forward post assembly and the aft post assembly are removably mountable to the aircraft. A carriage module is removably attachable to either one of the inboard side of the core module, via any one of the first sets of carriage-attachment elements, or the outboard side of the core module, via any one of the second sets of carriage-attachment elements. A suspension rack is mounted to the carriage module and configured to support a payload. The preceding subject matter of this paragraph characterizes example 1 of the present disclosure.

The pylon assembly includes a second carriage module removably attachable to either one of the inboard side of the core module, via any of the first sets of carriage-attachment elements, or to the outboard side of the core module, via any one of the second sets of carriage-attachment elements. The preceding subject matter of this paragraph characterizes example 2 of the present disclosure, wherein example 2 also includes the subject matter according to example 1, above.

When the carriage module is removably attached to either one of the inboard side of the core module or the outboard side of the core module, the second carriage module is removably attachable to the other one of the inboard side of the core module or the outboard side of the core module, such that the carriage module and the second carriage module are removably attachable to opposing sides of the core module. The preceding subject matter of this paragraph characterizes example 3 of the present disclosure, wherein example 3 also includes the subject matter according to example 2, above.

The pylon assembly includes an upper core fairing removably attachable to a top surface of the core module and configured to interface with the aircraft. The preceding subject matter of this paragraph characterizes example 4 of the present disclosure, wherein example 4 also includes the subject matter according to any of examples 1-3, above.

The inboard side of the core module includes three first sets of carriage-attachment elements. The outboard side of the core module includes three second sets of carriage-attachment elements. The carriage module is attachable to any one of the three first sets of carriage-attachment elements and the three second sets of carriage-attachment elements, such that the carriage module is attachable to the core module in any one of a forward-inboard position, a center-inboard position, an aft-inboard position, a forward-outboard position, a center-outboard position, or an aft-outboard position. The preceding subject matter of this paragraph characterizes example 5 of the present disclosure, wherein example 5 also includes the subject matter according to any of examples 1-4, above.

The core module includes a central core structure, a forward core fairing that is removably attachable to a forward end of the central core structure and an aft core fairing that is removably attachable to an aft end of the central core structure. The preceding subject matter of this paragraph characterizes example 6 of the present disclosure, wherein example 6 also includes the subject matter according to any of examples 1-5, above.

The forward core fairing and the aft core fairing are interchangeable, such that either one of the forward core fairing or the aft core fairing is attachable to either one of the forward end or the aft end of the core module. The preceding subject matter of this paragraph characterizes example 7 of the present disclosure, wherein example 7 also includes the subject matter according to example 6, above.

The carriage module is symmetrical about a plane of symmetry that divides a forward portion of the carriage module from an aft portion of the carriage module. The preceding subject matter of this paragraph characterizes example 8 of the present disclosure, wherein example 8 also includes the subject matter according to any of examples 1-7, above.

The carriage module includes a central carriage structure, a first carriage fairing coupled to a forward end of the central carriage structure, and a second carriage fairing coupled to an aft end of the central carriage structure. The first carriage fairing and the second carriage fairing are mirror images of each other. The preceding subject matter of this paragraph characterizes example 9 of the present disclosure, wherein example 9 also includes the subject matter according to any of examples 1-8, above.

The suspension rack is mounted to the carriage module at an oblique angle relative to a vertical plane of the core module that divides an inboard side of the core module from an outboard side of the core module. When a payload is supported by the suspension rack, the payload is angled at the oblique angle relative to the vertical plane of the core module. The preceding subject matter of this paragraph characterizes example 10 of the present disclosure, wherein example 10 also includes the subject matter according to any of examples 1-9, above.

Also disclosed herein is an aircraft system including an aircraft having multiple mounting hardpoint pairs. A pylon assembly is removably mountable to any one of the multiple mounting hardpoint pairs. The pylon assembly includes a core module including multiple sets of carriage-attachment elements, a carriage module removably attachable to any one of the multiple sets of carriage-attachment elements of the core module, and a suspension rack mounted to the carriage module and configured to support a payload. At least one of the multiple mounting hardpoint pairs is located on a left side of the aircraft and at least another one of the multiple mounting hardpoint pairs is located on a right side of the aircraft. The core module is reconfigurable for left side attachment to the at least one of the multiple mounting hardpoint pairs on the left side of the aircraft or right side attachment to the at least another one of the multiple mounting hardpoint pairs on the right side of the aircraft. The preceding subject matter of this paragraph characterizes example 11 of the present disclosure.

The core module includes an inboard side having first sets of carriage-attachment elements and an outboard side, opposite of the inboard side and having second sets of carriage-attachment elements. The carriage module is removably attachable to either one of the inboard side of the core module, via any one of the first sets of carriage-attachment elements, or the outboard side of the core module, via any one of the second sets of carriage-attachment elements. The preceding subject matter of this paragraph characterizes example 12 of the present disclosure, wherein example 12 also includes the subject matter according to example 11, above.

The aircraft system includes a second carriage module removably attachable to either one of the inboard side of the core module, via any of the first sets of carriage-attachment elements, or to the outboard side of the core module, via any one of the second sets of carriage-attachment elements. The preceding subject matter of this paragraph characterizes example 13 of the present disclosure, wherein example 13 also includes the subject matter according to example 12, above.

The aircraft system includes a forward post assembly extending from a forward portion of the core module and removably mountable to a forward mounting hardpoint of one of the multiple mounting hardpoint pairs. An aft post assembly extending from an aft portion of the core module and removably mountable to an aft mounting hardpoint of one of the multiple mounting hardpoint pairs. The preceding subject matter of this paragraph characterizes example 14 of the present disclosure, wherein example 14 also includes the subject matter according to any of examples 11-13, above.

The aircraft system includes an upper core fairing removably attachable to a top surface of the core module and configured to interface an exterior surface of the aircraft. The upper core fairing is specific to a select one of the multiple mounting hardpoint pairs. When the pylon assembly is mounted to the aircraft, the core fairing corresponds with an outer mold line of the exterior surface of the aircraft. The preceding subject matter of this paragraph characterizes example 15 of the present disclosure, wherein example 15 also includes the subject matter according to any of examples 11-14, above.

When the pylon assembly is mounted to one of the multiple mounting hardpoint pairs, the core module is parallel to a longitudinal axis of the aircraft. The preceding subject matter of this paragraph characterizes example 16 of the present disclosure, wherein example 16 also includes the subject matter according to any of examples 12-15, above.

The aircraft includes at least one weapons bay with opposing doors that are openable outward toward the left side and the right side of the aircraft. The pylon assembly is removably mountable to the aircraft adjacent to one of the opposing doors of the at least one weapons bay. When the pylon assembly is mounted adjacent to one of the opposing doors of the at least one weapons bay, and when the carriage module is attached to the inboard side of the core module, via any one of the first sets of carriage-attachment elements, the opposing doors of the at least one weapons bay are partially openable. When the pylon assembly is mounted adjacent to one of the opposing doors of the at least one weapons bay, and when the carriage module is attached to the outboard side of the core module, via any one of the second sets of carriage-attachment elements, the opposing doors of the at least one weapons bay are fully openable. The preceding subject matter of this paragraph characterizes example 17 of the present disclosure, wherein example 17 also includes the subject matter according to example 12, above.

Additionally disclosed herein is a method of attaching a payload to an aircraft including removably mounting a core module of a pylon assembly to a selected one of multiple mounting hardpoint pairs located on either a left side or a right side of an aircraft. The core module is reconfigurable for left side attachment to one of the multiple mounting hardpoint pairs on the left side or right side attachment to one of the multiple mounting hardpoint pairs on the right side of the aircraft. The method also includes removably attaching a carriage module to any one of multiple sets of carriage-attachment elements of the core module. A suspension rack is mounted to the carriage module at an oblique angle relative to a vertical plane of the core module that divides an inboard side of the core module from an outboard side of the core module. The method further includes removably attaching a payload to the suspension rack. The payload is angled at an oblique angle relative to the vertical plane of the core module. The preceding subject matter of this paragraph characterizes example 18 of the present disclosure.

The core module includes an inboard side having first sets of carriage-attachment elements and an outboard side, opposite of the inboard side and having second sets of carriage-attachment elements. Removably attaching the carriage module to any one of the multiple sets of carriage-attachment elements of the core module includes attaching the carriage module to either one of the inboard side of the core module, via any one of the first sets of carriage-attachment elements, or the outboard side of the core module, via any one of the second sets of carriage-attachment elements. The preceding subject matter of this paragraph characterizes example 19 of the present disclosure, wherein example 19 also includes the subject matter according to example 18, above.

Removably attaching a second carriage module to another one of the multiple sets of carriage-attachment elements of the core module, such that the carriage module and the second carriage module are attached to opposing sides of the core module. A second suspension rack is mounted to the second carriage module at an oblique angle relative to the vertical plane of the core module and the suspension rack and the second suspension rack are angled away from each other. Removably attaching a second payload to the second suspension rack, such that the second payload is angle at an oblique angle relative to the vertical plane of the core module. The preceding subject matter of this paragraph characterizes example 20 of the present disclosure, wherein example 20 also includes the subject matter according to any of examples 18-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic perspective view of a pylon assembly, according to one or more examples of the present disclosure;

FIG. 2 is a schematic bottom plan view of an aircraft, with multiple mounting hardpoint pairs, according to one or more examples of the present disclosure;

FIG. 3 is a schematic, perspective, exploded view of a pylon assembly, with two carriage modules, according to one or more examples of the present disclosure;

FIG. 4 is a schematic, perspective, exploded view of a core module, according to one or more examples of the present disclosure;

FIG. 5 is a schematic perspective view of a core module, shown configured for right side attachment and configured for left side attachment, according to one or more examples of the present disclosure;

FIG. 6A is a schematic front elevation view of a pylon assembly, with one carriage module attached in an inboard-attachment position, according to one or more examples of the present disclosure;

FIG. 6B is a schematic front elevation view of the pylon assembly of FIG. 6A, with one carriage module attached in an outboard-attachment position, according to one or more examples of the present disclosure;

FIG. 6C is a schematic front elevation view of the pylon assembly of FIG. 6A, with two carriage modules attached in a dual-carriage configuration, according to one or more examples of the present disclosure;

FIG. 7A is a schematic side elevation view of a core module, with the outboard side shown, according to one or more examples of the present disclosure;

FIG. 7B is a schematic side elevation view of the core module of FIG. 7A, with the inboard side shown, according to one or more examples of the present disclosure;

FIG. 7C, is a schematic side elevation view of a carriage module, according to one or more examples of the present disclosure;

FIG. 8A is a schematic perspective view of a pylon assembly, with a carriage module in a forward-inboard position, according to one or more examples of the present disclosure;

FIG. 8B is a schematic perspective view of the pylon assembly of FIG. 8A, with the carriage module in a center-inboard position, according to one or more examples of the present disclosure;

FIG. 8C is a schematic perspective view of the pylon assembly of FIG. 8A, with the carriage module in an aft-inboard position, according to one or more examples of the present disclosure;

FIG. 8D is a schematic perspective view of the pylon assembly of FIG. 8A, with the carriage module in a forward-outboard position, according to one or more examples of the present disclosure;

FIG. 8E is a schematic perspective view of the pylon assembly of FIG. 8A, with the carriage module in a center-outboard position, according to one or more examples of the present disclosure;

FIG. 8F is a schematic perspective view of the pylon assembly of FIG. 8A, with the carriage module in an aft-outboard position, according to one or more examples of the present disclosure;

FIG. 9A is a schematic front elevation view of an aircraft, with a pylon in a left side attachment having dual carriage modules and a pylon in a right side attachment having dual carriage modules, and opposing doors of a weapons bay partially open, according to one or more examples of the present disclosure;

FIG. 9B is a schematic front elevation view of the aircraft of FIG. 9A, with a payload attached to the dual carriage modules of the pylon in the left side attachment, and a payload attached to the dual carriage modules of the pylon in the right side attachment, and opposing doors of the weapons bay partially open, according to one or more examples of the present disclosure;

FIG. 10 is a schematic front elevation view of the aircraft of FIG. 9A, with a pylon in a left side attachment having a carriage module in an outboard side attachment and a pylon in a right side attachment having a carriage module in an outboard side attachment, and opposing doors of a weapons bay fully open, according to one or more examples of the present disclosure; and

FIG. 11 is a schematic flow chart of a method of attaching a payload to an aircraft, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Some conventional pylons impose limitations on aircraft payload capabilities as their weight and size restrictions prevent the transportation of heavier and larger payloads, such as hypersonic weapons, reducing versatility and necessitating additional missions. Additionally, some conventional pylons, including those that have multiple payload capacity, obstruct the full opening of adjacent weapons bay doors and require the complete removal of pylons to fully open the weapon bay doors. Furthermore, conventional pylons placed near critical components, like the main landing gear, introduce proximity constraints, which can complicate the carriage of long-nose ordnance or other equipment (e.g., may require long-nose ordnances to clear main landing gear doors, which may potentially interfere with aircraft operations).

Disclosed herein is a modular pylon assembly having increased functionality, versatility, and payload capability over conventional pylons. The pylon assembly includes an arrangement of sub-component building blocks that allows for adaptation to multiple mounting hardpoints on an aircraft (e.g., the B-1B bomber), which can enable optimization of the payload capacity of the aircraft. The pylon assembly includes an ambidextrous core module that can be reconfigured for left side or right side attachment to the aircraft, thus enhancing the versatility of the pylon. The core module includes attachment provisions (i.e., sets of carriage-attachment elements) for up to two carriage modules on opposing sides of the core module (i.e., inboard and outboard side). The carriage module is enabled for attachment and detachment from the core module, allowing the weapons bay doors to be fully openable without the need for complete removable of the pylon assembly. Moreover, the carriage module is symmetrical forward and aft, enabling it to be attached to either the inboard side or the outboard side of the core module without requiring sub-component modifications.

The carriage module can be secured to any of the sets of carriage-attachment elements on the core module, whether positioned forward, center, aft, inboard, or outboard. This modularity of the pylon assembly enables the location of the carriage module relative to the core module to be adjustable, thus reducing proximity constraints and ensuring that payloads, including long nose ordnance, can be safely carried without interfering with aircraft operations. In some examples, the positioning of the carriage modules on opposing side of the core module, with one side forward and the other aft, helps prevent interference between larger fin ordnance carried on the inboard and outboard sides of the same pylon assembly. This staggered configuration ensures that the payloads on either side of the pylon assembly, particularly those with larger fins, do not interfere with each other, optimizing the carriage of diverse payloads by a single pylon assembly.

Additionally, the side (e.g., shoulder) attached of the carriage module to the core module allows the suspension racks to be positioned closer to the attachment locations (i.e., hardpoint pairs) of the aircraft, enabling the pylon assembly to carry additional payload weight. In some examples, the closer proximity enabling supporting up to two 4000 lb. payloads. Accordingly, the adaptable design of the pylon assembly enables an aircraft to carry a wider variety and larger quantity of payloads, thereby enhancing the operational capabilities of the aircraft.

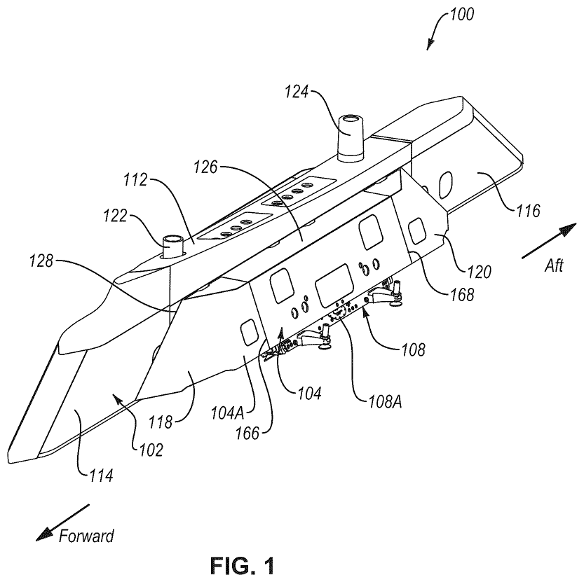

According to some examples, a pylon assembly 100 is shown in FIG. 1. The pylon assembly 100 includes a core module 102, an upper core fairing 112, and at least one carriage module 104 that is removably attachable to the core module 102. The core module 102 is ambidextrous, meaning that the core module 102 can be configured for use on either a left side or a right side of an aircraft, allowing the pylon assembly 100 to adapt to multiple placement configurations on an aircraft.

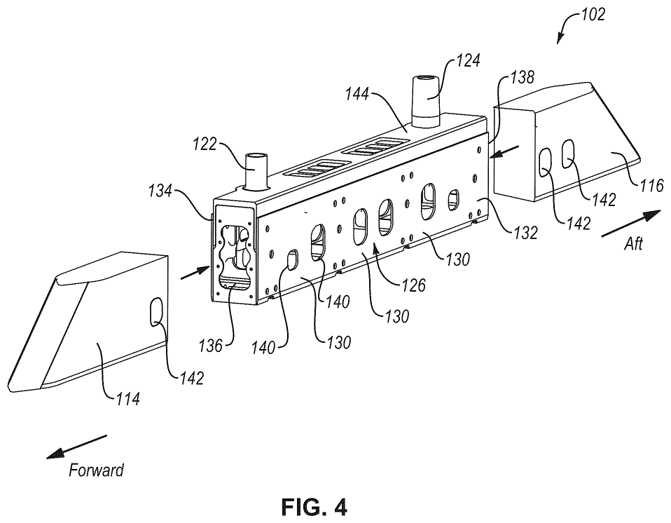

The core module 102 includes a central core structure 128, a forward core fairing 114, and an aft core fairing 116. As shown in FIG. 4, the forward core fairing 114 is removably attachable to a forward end 136 of the central core structure 128 and the aft core fairing 116 is removably attachable to an aft end 138 of the central core structure 128. The forward core fairing 114 and the aft core fairing 116 are configured to maintain aerodynamic efficiency. A forward post assembly 122 extends from a forward portion of the core module 102 and an aft post assembly 124 extends from an aft portion of the core module 102. Specifically, the forward post assembly 122 and the aft post assembly 124 extend from a top surface 144 of the core module 102 and are configured to mount to mounting hardpoint pairs on an aircraft, such that when the pylon assembly 100 is mounted, the pylon assembly 100 extends vertically downward from the aircraft's lower outer mold line (e.g., fuselage).

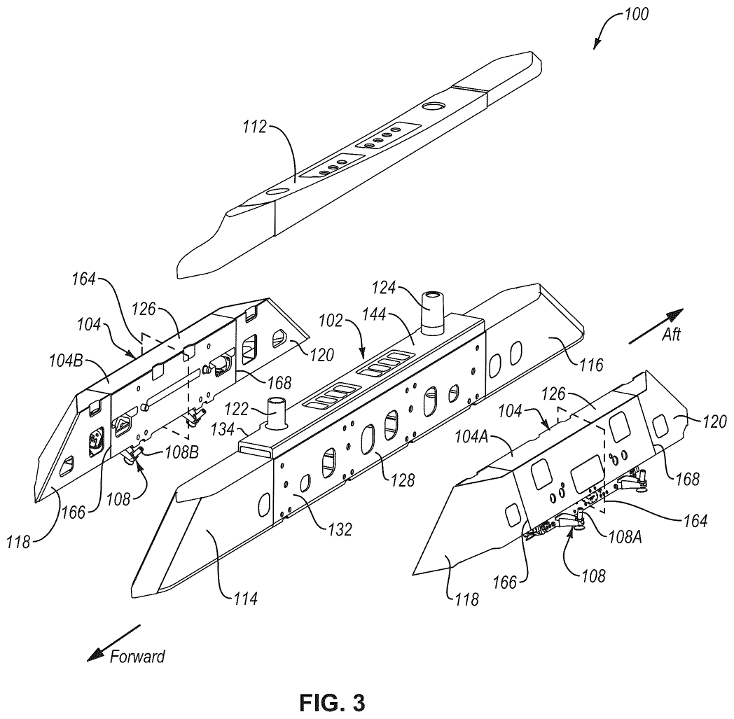

Referring back to FIG. 1, the carriage module 104, which is symmetrical in design, is removably attached to the core module 102. The carriage module 104 includes a central carriage structure 126, a first carriage fairing 118, and a second carriage fairing 120. The first carriage fairing 118 and the second carriage fairing 120 are attached to a forward end 166 and an aft end 168, respectively, of the central carriage structure 126 and configured to maintain aerodynamic efficiency. The core module 102 can accommodate either one or two carriage modules 104. For example, only a first carriage module 104A may be attached to the core module 102 in one implementation, or both the first carriage module 104A and a second carriage module 104B are attached to the core module 102 in another implementation. As shown, the first carriage module 104A is removably attached to the core module 102. Although not depicted in FIG. 1, the second carriage module 104B can also be removably attached to the core module 102, such that the first carriage module 104A and second carriage module 104B are positioned on opposing sides of the core module 102 (see, e.g., FIG. 3).

A suspension rack 108 is mounted to the carriage module 104 and configured to support a payload (not shown). Specifically, a first suspension rack 108A is mounted to the first carriage module 104A. The suspension rack 108 is configured to interface with various types of ordnance and equipment (i.e. payload) and provide secure and stable attachable points.

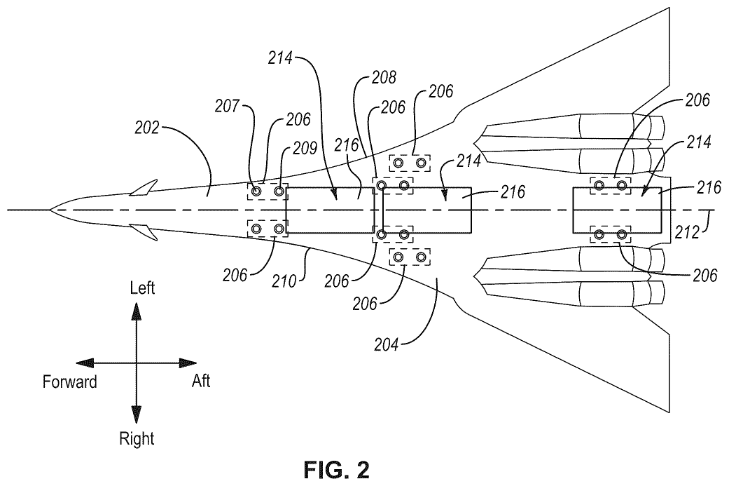

Referring to FIG. 2, a representative aircraft, such as aircraft 202, suitable for mounting the pylon assembly 100 is shown. The aircraft 202 may be any aircraft configured to carry external payloads. For example, the aircraft 202 could be a military bomber, such as the B-1B Bomber, which is designed to carry a wide variety of ordnance and other external payloads. The aircraft 202 includes multiple mounting hardpoint pairs 206 on an exterior surface 204. Each one of the mounting hardpoint pairs 206 is configured to securely mount external equipment, such as the pylon assembly 100. The multiple mounting hardpoint pairs 206 are positioned symmetrically on a left side 208 and a right side 210 of the aircraft 202. That is, for each mounting hardpoint pair on the left side 208, there is a corresponding mounting hardpoint pair 206 on the right side 210, allowing pylon assemblies 100 to be balanced and evenly distributed to each side of the aircraft 202.

Each one of the mounting hardpoint pairs 206 consists of two hardpoints aligned linearly and parallel to a longitudinal axis 212 of the aircraft 202. The forward hardpoint of each mounting hardpoint pair 206 is a forward mounting hardpoint 207, while the aft hardpoint of each mounting hardpoint pair 206 is an aft mounting hardpoint 209. The forward post assembly 122 of the pylon assembly 100 is configured to be removably mountable to the forward mounting hardpoint 207 and the aft post assembly 124 is configured to be removably mountable to the aft mounting hardpoint 209 (not shown). When a pylon assembly 100 is mounted to one of the multiple mounting hardpoint pairs 206, the core module 102 is positioned parallel to the longitudinal axis 212 of the aircraft 202.

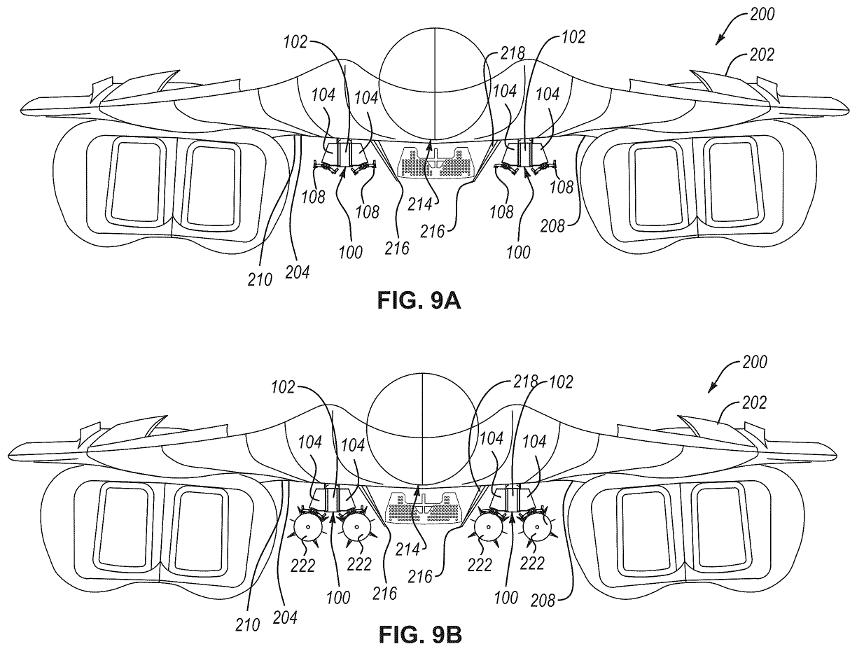

In some examples, the aircraft 202 includes at least one weapons bay 214 with opposing doors 216 that are openable toward the left side 208 and the right side 210 of the aircraft 202. At least some of multiple mounting hardpoint pairs 206 may be located adjacent to a corresponding weapons bay 214, such that opposing doors 216 of the weapons bay 214 are openable outward toward a corresponding one of the multiple mounting hardpoint pairs 206. Accordingly, in some examples, when a pylon assembly 100 is removably mounted to the aircraft 202, the pylon assembly 100 may be adjacent to one of the opposing doors 216 of a weapon bay 214 (see, e.g., FIG. 9A).

As shown in FIG. 3, in some examples, the pylon assembly 100 includes two carriage modules 104, such as the first carriage module 104A and the second carriage module 104B. As shown, the first carriage module 104A is attachable to an outboard side 132 of the core module 102 and the second carriage module 104B is attachable to an inboard side 134 of the core module 102. When attached, the first carriage module 104A and the second carriage module 104B are on opposite sides (e.g., outboard and inboard sides) of the core module 102. As used herein, the outboard side 132 refers to the side of the aircraft facing away from the longitudinal axis 212, while the inboard side 134 refers to the side facing towards the longitudinal axis 212 (see, e.g., FIG. 2).

The carriage module 104 is symmetric about a plane of symmetry 164 that divides a forward portion of the carriage module 104 from an aft portion of the carriage module 104. In other words, if the carriage module 104 were to be cut along the plane of symmetry 164, the two resulting halves would be mirror images of each other. Moreover, the first carriage fairing 118 and the second carriage fairing 120 are mirror images of each other. Due to this symmetry, the carriage module 104 can be reversed to be attached to either side of the core module 102. Accordingly, the first carriage module 104A can be attached to the outboard side 132, or reversed and attached to the inboard side 134 of the core module 102. For the purposes of this description, the first carriage fairing 118 is considered the fairing forward of the central carriage structure 126 and the second carriage fairing 120 is considered the fairing aft of the central carriage structure 126, regardless of which side of the core module 102 the carriage module 104 is located. Since the carriage fairings are mirror images of each other, either one can be positioned in the forward or aft position. Therefore, the first carriage fairing 118 and the second carriage fairing 120 are interchangeable.

The pylon assembly 100 also includes an upper core fairing that is removably attachable to a top surface 144 of the core module 102. The upper core fairing 112 serves to streamline the interface between the pylon assembly 100 and the aircraft 202, ensuring aerodynamic efficiency and reducing drag by fitting tightly against the aircraft's outer mold line (OML) of the exterior surface 204. Due to the specific aerodynamic and structural requirements, the upper core fairing 112 is a non-configurable component of the pylon assembly 100. That is, the upper core fairing 112 is tailored to either the left side 208 or the right side 210 of the aircraft 202. Consequently, there is an upper core fairing 112 specifically designed for a pylon assembly 100 that attaches to the left side 208 of the aircraft 202 and a different upper core fairing 112 for a pylon assembly 100 that attaches to the right side 210 of the aircraft 202. Additionally, in some examples, the upper core fairing 112 may be specifically designed to be mounted to a particular one of the mounting hardpoint pairs 206 on either the left side 208 or the right side 210 of the aircraft 202. That is, at least one mounting hardpoint pair 206 on the left side 208 of the aircraft may require a different upper core fairing 112 than other mounting hardpoint pairs 206 on the left side 208. Similarly, in some examples, the same may applies to the right side 210 of the aircraft 202. For example, a first left upper core fairing may be configured to interface with a forwardmost left mounting hardpoint pair, while a second left upper core fairing may be configured to interface with an intermediate left mounting hardpoint pair and an aftmost left mounting hardpoint pair.

As shown in FIG. 4, the core module 102 includes sets of carriage-attachment elements 130. Specifically, the sets of carriage-attachment elements 130 are located on the central core structure 128. Each one of the sets of carriage-attachment elements 130 includes multiple individual elements, allowing the carriage module 104 to be securely attached to the core module at multiple points. The core module 102 has sets of carriage-attachment elements 130 on both the outboard side 132 and the inboard side 134 of the core module 102, such that the carriage module 104 can be attached to either side of the core module 102. The core module 102 also includes various access openings that allow access from its exterior to the interior. In some examples, an access opening may be used to extend an object from the interior of the core module 102 to the exterior. For example, the central core structure 128 may include a plurality of access openings 140 that allow a wire harness to extend from the interior of the core module 102 to the exterior, to facilitate the connection of electrical components and systems. The wire harness provides the necessary electrical pathways for power and signal transmission, ensuring proper operation of the pylon assembly's various subsystems. Moreover, the forward core fairing 114 and the aft core fairing 116 may also include at least one access opening 142. Although shown with a certain number of access openings, any number of access openings may be included on the core module 102.

Similar to the carriage fairings, in some examples, the forward core fairing 114 and the aft core fairing 116 are interchangeable. That is, either one of the forward core fairing 114 and the aft core fairing 116 is attachable to either one of the forward end 136 or the aft end 138 of the core module 102. Accordingly, the forward core fairing 114 or the aft core fairing 116 and can be attached to the forward end 136, or reversed and attached to the aft end 138. For the purposes of this description, the forward core fairing 114 is considered the fairing forward of the core module 102 and the aft core fairing 116 is considered the fairing aft of the core module 102, regardless of which fairing is attached in either position. Moreover, in certain examples, the forward core fairing 114 and the aft core fairing 116 are mirror images of each other, ensuring that the aerodynamic benefits are the same regardless of their positions. As shown, the forward core fairing 114 has one access opening 142, while the aft core fairing 116 has two access openings 142. The difference in the number of access openings may affect the interchangeability in certain configurations where specific access points are required for wiring or other purposes.

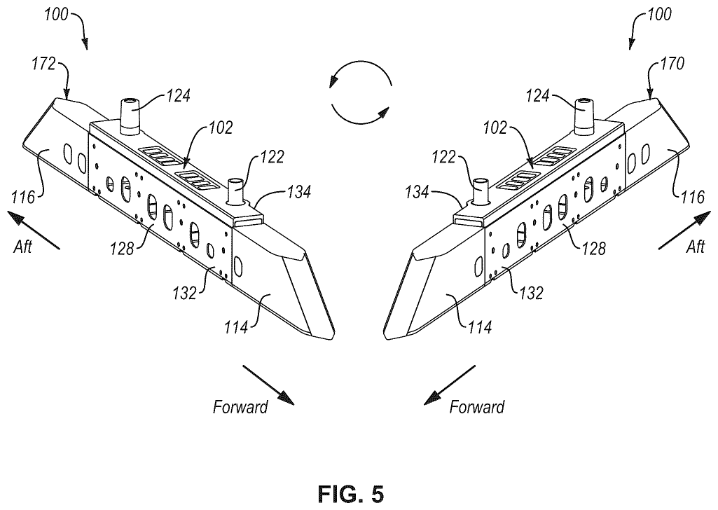

Referring to FIGS. 5, 9A-9B and 10, the core module 102 is reconfigurable for attachment to a left side 208 or a right side 210 of the aircraft 202. As shown in the left figure in FIG. 5, is a core module 102 in a right side attachment configuration 172 for right side attachment to the aircraft 202, and on the right is the same core module 102 but configured in a left side attachment configuration 170 for left side attachment to the aircraft 202. The core module 102 can be reconfigured from the left to the right, or vice versa, by reversing the direction of the core module 102 and swapping the location of the forward post assembly 122 and the aft post assembly 124, so that the forward post assembly 122 is forward of the aft post assembly 124 in either configuration. Additionally, in some examples, the forward core fairing 114 and the aft core fairing 116 can be swapped to opposite ends of the central core structure 128 when reconfiguring the core module 102. In certain examples, if the forward core fairing 114 and the aft core fairing 116 are mirror images of each other, they do not need to be swapped. This modularity allows the core module 102 to adapt to multiple mounting hardpoint pair configurations on the aircraft 202. The need to reverse the core module 102 when reconfiguring from side to side, is due to a necessary offset of a core centerline. Specifically, the core centerline is offset outboard of the mounting hardpoint pairs centerline when the pylon assembly 100 is mounted to the aircraft 202. Accordingly, the forward post assembly 122 and the aft post assembly 124 must always be closer to the inboard side 134 to position the core centerline further away from the mounting hardpoint pairs centerline, thus positioning the core module 102 further away from the weapons bay. Reversing the core module 102 when converting the pylon assembly 100 from left to right, or vice versa, allows the offset to be maintained, ensuring the pylon assembly 100 is correctly positioned outboard and preventing interference of the core module 102 with the opening of the weapons bay door.

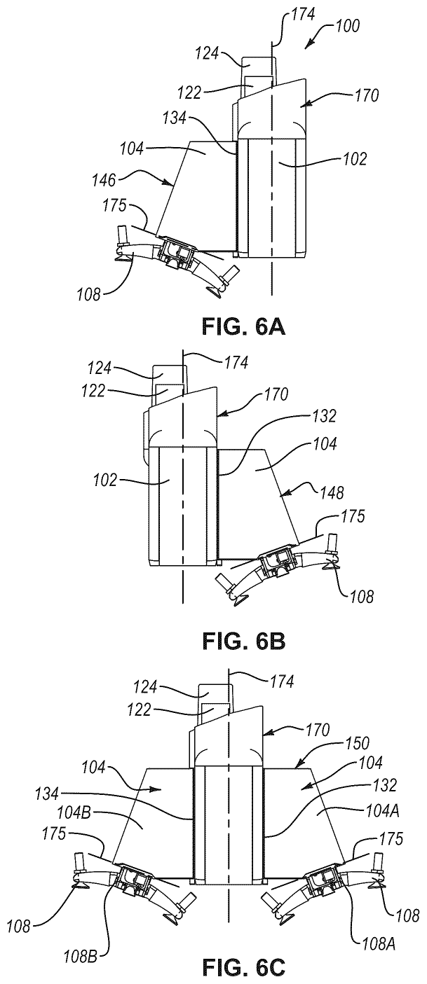

Referring to FIG. 6A-6C, some configurations for attaching the carriage module 104 to the outboard side 132 and inboard side 134 of the core module 102 are shown. As depicted, the core module 102 is configured in the left side attachment configuration 170 for left side attachment to the aircraft 202. A vertical plane 174 is shown extending through the core centerline, that is, dividing the inboard side 134 from the outboard side 132 of the core module 102. As can be more fully appreciated from these front views, the forward post assembly 122 and the aft post assembly 124 are offset from the core centerline, positioned closer to the inboard side 134 of the core module 102.

Referring to FIG. 6A, the pylon assembly 100 is shown having one carriage module 104 attached to the inboard side 134 of the core module 102, such that the carriage module 104 is in an inboard-attachment position 146. The suspension rack 108 is mounted to the carriage module 104 at an oblique angle relative to the vertical plane 174 of the core module 102, such that it extends outwardly from the core module 102. The suspension rack 108 is specifically mounted at a mounting plane 175, which is angled. Accordingly, when a payload is supported by the suspension rack 108, the payload is angled at an oblique angle relative to the vertical plane 174 of the core module 102. The angled configuration of the suspension rack 108 positions an attached payload away from the core centerline. When the carriage module 104 is in the inboard-attachment position 146, the opposing doors of an adjacent weapons bay are only partially openable (see, e.g., FIG. 9A). This is due to the positioning of the carriage module 104, which extends into the path of the weapons bay door, obstructing its full range of motion.

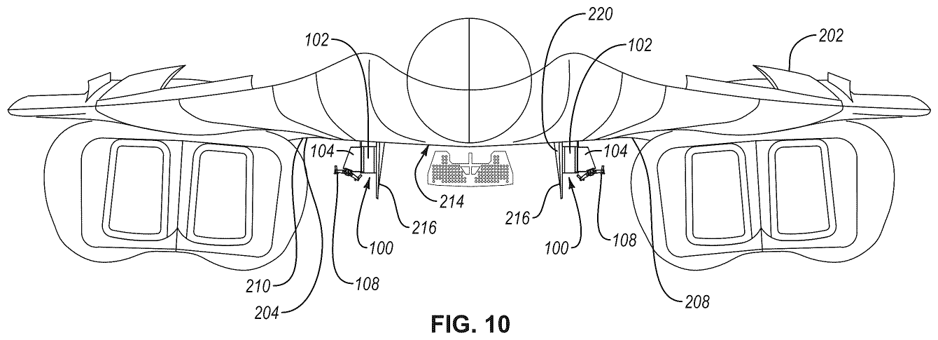

Similarly, referring to FIG. 6B, the pylon assembly 100 is shown having one carriage module 104 attached to the outboard side 132 of the core module 102, such that the carriage module 104 is in an outboard-attachment position 148. Like the carriage module 104 in the inboard-attachment position 146, the suspension rack 108 is mounted at an oblique angle relative to the vertical plane 174 of the core module 102, extending outwardly from the core module 102 in the opposite direction. The angled configuration of the suspension rack 108 positions an attached payload away from the core centerline. When the pylon assembly 100 only has a carriage module 104 is in the outboard-attachment position 148, the opposing doors of an adjacent weapons bay are fully openable (see, e.g., FIG. 10). This is due to the positioning of the carriage module 104, which does not extend into the path of the weapons bay door, allowing its full range of motion. Additionally, the angled configuration of the suspension rack 108 ensures that any attached payload does not interfere with the operation of the weapons bay door.

Referring to FIG. 6C, the pylon assembly 100 is shown having two carriage modules 104, a first carriage module 104A is attached to the outboard side 132 of the core module 102 and a second carriage module 104B is attached to the inboard side 134 of the core module 102, such that the pylon assembly is in a dual-carriage configuration 150. Accordingly, a first suspension rack 108A is mounted to the first carriage module 104A at an oblique angle, and a second suspension rack 108B is mounted to the second carriage module 104B at an oblique angle in the opposite direction of the first suspension rack 108A. In the dual-carriage configuration 150, the opposing angles of the suspension racks allow each carriage module 104 to attach a payload without interfering with the other.

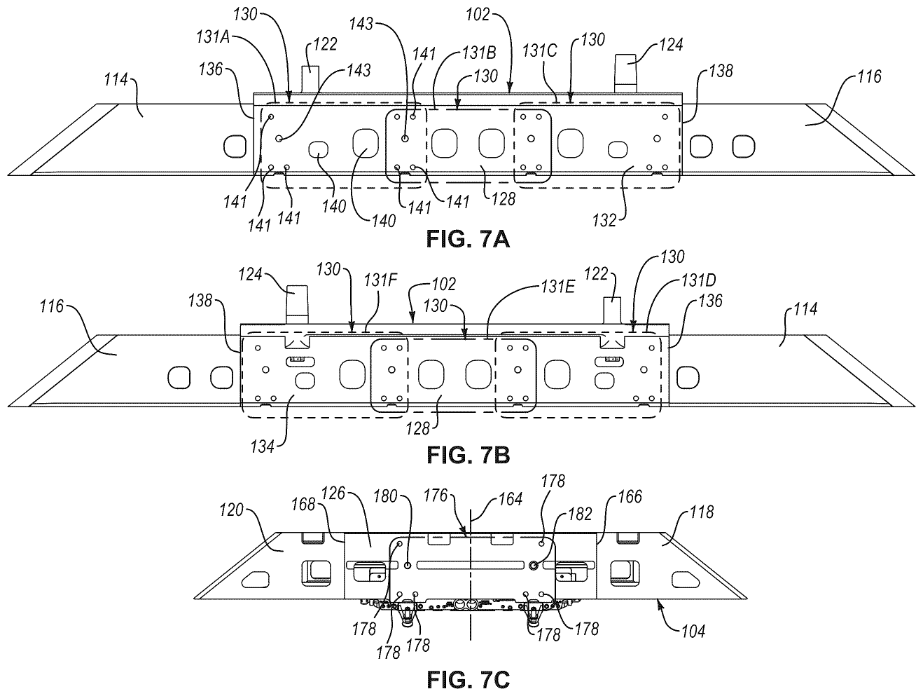

As shown in FIGS. 7A and 7B, the core module 102 includes sets of carriage-attachment elements 130, which are used to attach the corresponding carriage module 104 to the core module 102. The core module 102 may include any number of sets of carriage-attachment elements 130, including more of less than the six sets shown. Referring to FIG. 7A, which illustrates the outboard side 132 of the core module 102, the outboard side 132 includes first sets of carriage-attachment elements. In some examples, the first sets of carriage-attachment elements 130 may include three first sets, each shown in a dashed outline. For example, a first set of carriage-attachment elements 131A, a second set of carriage-attachment elements 131B, and a third set of carriage-attachment elements 131C. Each one of the first sets of carriage-attachment elements 130 includes multiple individual elements 141, labeled in the first set of carriage-attachment elements 131A, which includes six individual elements 141, three positioned closer to the forward end 136 and three positioned closer to the aft end 138. However, each set of carriage-attachment elements 130 may include any number of individual elements 141, including more of less than the six individual elements 141 shown. The individual elements 141 may be bolt holes, mounting brackets, locking pins, or other attachment elements capable of attaching the carriage module 104 to the core module 102.

In some examples, certain ones of the individual elements 141 may be shared by multiple sets of carriage-attachment elements 130. For example, the second set of carriage-attachment elements 131B may share two of the individual elements 141 from the first set of carriage-attachment elements 131A and share two from the third set of carriage-attachment elements 131C. This may be done to improve modularity and reducing redundancy in the design of the core module 102.

Referring to FIG. 7B, similar to the outboard side 132, the inboard side 134 of the core module 102 is shown including second sets of carriage-attachment elements. In some examples, the second sets of carriage-attachment elements 130 may include three second sets of carriage-attachment elements 130. For example, a fourth set of carriage-attachment elements 131D, a fifth set of carriage-attachment elements 131E, and a sixth set of carriage-attachment elements 131F.

The carriage module 104, shown in FIG. 7C, is configured to be attachable to any one of the sets of carriage-attachment elements 130. Specifically, the carriage module 104 includes one set of core-attachment elements 176, including multiple individual elements 178 that correspond to the individual elements 141 of each one of the sets of carriage-attachment elements. In other words, the set of core-attachment elements 176 of the carriage module 104 is designed to align with and secure to the individual elements 141 of any selected set of carriage-attachment elements 130, allowing for flexible and secure attachment configurations.

The carriage module 104 may also include pins to further secure the carriage module 104 to the core module 102. In some examples, the carriage module 104 includes a fixed pin 180 and a floating pin 182. The fixed pin 180 is configured to fit tightly within a corresponding pin hole 143 on the core module 102, restraining the movement of the carriage module 104 relative to the core module 102 in both up/down directions and forward/aft directions. The floating pin 182 is also fits within a corresponding pin hole 143 on the core module 102 but only restrains the carriage module 104 in up/down directions. This allows the floating pin 182 to move in the forward/aft directions, accommodating small misalignments between the pins on the carriage module 104 and the pin holes 143 on the core module 102, while still supporting carriage loads in the up/down directions.

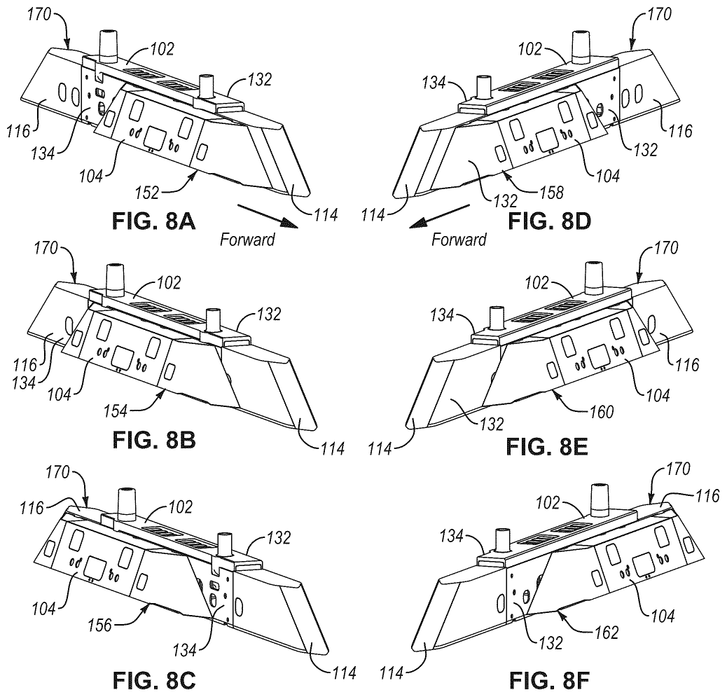

FIGS. 8A-8F illustrate various examples of the carriage module 104 placement relative to the core module 102. Specifically, in some examples, the carriage module 104 can be attached not only to the inboard side 134 or the outboard side 132 but also to different locations along these sides. In other words, by utilizing one of the sets of carriage-attachment elements 130, the carriage module 104 can be positions at different locations relative to the core module 102. This positioning allows for optimal weight distribution and aerodynamic efficiency. By selecting different sets of carriage-attachment elements 130, the carriage module 104 can be adjusted to accommodate various payload sizes and shapes, ensuring the optimized or balanced load distribution to each hardpoint pair of the aircraft is maintained. Additionally, the flexibility in positioning helps to avoid interference with other aircraft components, such as landing gear or weapon bay doors, enhancing the overall operational capability of the aircraft.

FIGS. 8A through 8C illustrate various placements of the carriage module 104 on the inboard side 134 of the core module 102, while FIGS. 8D through 8F show placements on the outboard side 132. As shown in FIG. 8A, the carriage module 104, shown in the left side attachment 170 configuration, is in a forward-inboard position 152. Specifically, the carriage module 104 is attached to the fourth set of carriage-attachment elements 131D (see, e.g., FIG. 7B). This positioning aligns the carriage module 104 near the forward end of the core module 102, allowing for optimal forward payload placement. In FIG. 8B, the carriage module 104, is in a center-inboard position 154. The carriage module 104 is attached to the fifth set of carriage-attachment elements 131E (see, e.g., FIG. 7B). This placement centers the carriage module 104 along the length of the core module 102, balancing the payload distribution. Shown in FIG. 8C, the carriage module 104, is in an aft-inboard position 156. Specifically, the carriage module 104 is attached to the sixth set of carriage-attachment elements 131F (see, e.g., FIG. 7B). This positioning places the carriage module 104 towards the aft end of the core module 102, suitable for rear payload placement.

In FIG. 8D, the carriage module 104 is shown in a forward-outboard position 158. The carriage module 104 is attached to the first set of carriage-attachment elements 131A (see, e.g., FIG. 7A). This positioning places the carriage module 104 near the forward end of the outboard side 132, facilitating forward external payload attachment. FIG. 8E depicts the carriage module 104 in a center-outboard position 160. The carriage module 104 is attached to the second set of carriage-attachment elements 131B (see, e.g., FIG. 7A). This placement centers the carriage module 104 on the outboard side 132 of the core module 102, providing balanced payload distribution externally. Finally, as shown in FIG. 8F, the carriage module 104 is in an aft-outboard position 162. The carriage module 104 is attached to the third set of carriage-attachment elements 131C (see, e.g., FIG. 7A). This positioning places the carriage module 104 towards the aft end on the outboard side 132, ideal for rear external payload placement.

Referring to FIGS. 9A and 9B, the aircraft 202 is shown with two pylon assemblies 100 each mounted to a mounting hardpoint pair 206 on either side of the aircraft 202, the left side 208 and the right side 210. FIG. 9A shows the pylon assemblies 100 without payloads, while FIG. 9B shows the pylon assemblies 100 with mounted payloads. The aircraft 202 includes a weapons bay 214 with opposing doors 216. As illustrated, each pylon assembly 100 includes two carriage modules 104, with a carriage module 104 in the inboard-attachment position and a carriage module 104 in the outboard-attachment position on the core module 102. In this configuration, the opposing doors 216 of the weapons bay 214 can only be partially opened, to a partially opened position 218, due to the placement of the carriage module 104 in the inboard-attachment position. Consequently, when a carriage module 104 is in the inboard-attachment position 146 the opening of the opposing doors 216 is restricted, limiting access to the weapons bay 214. However, by removing the carriage module 104 in the inboard-attachment position 146, the opposing doors 216 can be fully opened. In other words, there is no need to remove the entirety of the pylon assembly 100, just the carriage module 104, to fully open the opposing doors 216 and provide unrestricted access to the weapons bay 214.

Conversely, as shown in FIG. 10, the aircraft 202 is shown with two pylon assemblies 100, each with one carriage module 104 attached only in the outboard-attachment position on the core module 102. In this configuration, the opposing doors 216 of the weapons bay 214 can be fully opened, to a fully open position 220, allowing unobstructed access to the weapons bay 214. The positioning of the carriage modules 104 on the outboard side 132 of the core modules 102 ensures that any mounted payloads, attached via the suspension racks 108, does not interfere with the operation of the opposing doors 216.

Accordingly, the pylon assembly 100 is flexible in adapting to various operational requirements of the aircraft 202. The ability to reposition the carriage modules 104 between inboard and outboard attachment positions allows for the optimization of payload deployment and aircraft configuration. This adaptability helps to maximize the operational capabilities of the aircraft 202, ensuring that payloads 222 can be carried and deployed without hindering access to the weapons bay 214, if needed, or compromisingly aircraft functionality.

In some examples, the pylon assembly 100 can be mounted to the aircraft 202 as a complete unit, simplifying the installation process by attaching the core module 102, pre-assembled, along with any attached carriage modules 104 directly to the mounting hardpoint pairs 206 of the aircraft. Alternatively, in other examples, the pylon assembly 100 can be installed in stages by attaching sub-components individually. This involves first mounting the core module 102 to the selected mounting hardpoint pair 206. Once the core module 102 is securely attached and aligned, the carriage module 104 can be individually attached to the core module 102 via the sets of carriage-attachment elements 130. The modular approach of the pylon assembly 100 not only provides adaptability in terms of installation but also maintenance and reconfiguration capabilities of the pylon assembly 100, allowing for easy replacement or adjustment of individual components as needed. The pylon assembly 100 can also be removed either as a complete unit or by first detaching the carriage modules 104, followed by the core module 102.

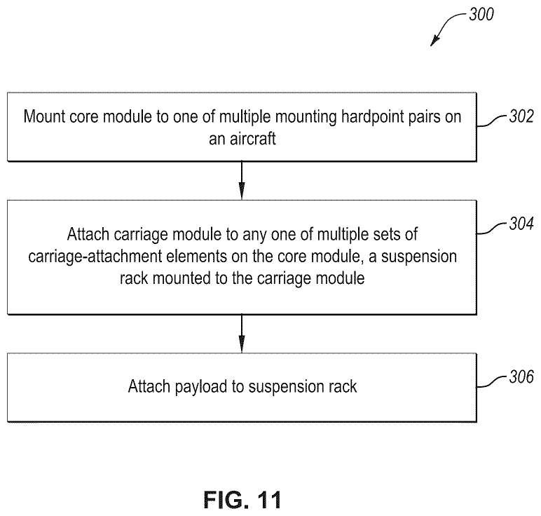

As shown in FIG. 11, a method 300 of attaching a payload 222 to an aircraft 202 is disclosed. The method 300 includes (block 302) removably mounting a core module 102 of a pylon assembly 100 to a selected one of multiple mounting hardpoint pairs 206 located on either a left side 208 or a right side 210 of an aircraft 202. The core module 102 being reconfigurable for left side attachment to one of the multiple mounting hardpoint pairs 206 on the left side 208 or right side attachment to one of the multiple mounting hardpoint pairs 206 on the right side 210 of the aircraft 202. The core module 102 can be adjusted by reversing the core module 102, swapping the forward post assembly 122 and aft post assembly 124 and, if necessary, repositioning the forward core fairing 114 and aft core fairing 116 to fit the selected mounting configuration.

The method 300 also includes (block 304) removably attaching a carriage module 104 to any one of the multiple sets of carriage-attachment elements 130 of the core module 102. In some examples, the core module 102 includes an inboard side 134 having first sets of carriage-attachment elements 130 and an outboard side 132, opposite of the inboard side 134 and having second sets of carriage-attachment elements 130. Accordingly, the carriage module 104 is attachable to either the inboard side 134 of the core module 102, via any one of the first sets of carriage-attachment elements 130, or the outboard side 132 of the core module 102, via any one of the second sets of carriage-attachment elements 130.

Moreover, a suspension rack 108 is mounted to the carriage module 104 at an oblique angle relative to a vertical plane 174 of the core module 102 that divides an inboard side 134 of the core module 102 from an outboard side 132 of the core module 102. The method 300 further includes (block 306) removably attaching a payload 222 to the suspension rack 108. When attached, the payload 222 is angled at an oblique angle relative to the vertical plane 174 of the core module 102. This angled configuration ensures that the attached payload 222 is optimally positioned away from the core centerline, ensuring clearance and reducing interference with aircraft operations.

Additionally, in some examples, a second carriage module 104B is removably attachable to another one of the multiple sets of carriage-attachment elements 130 of the core module 102. This configuration allows two carriage module to be attached to opposing sides of the core module 102. In this arrangement, a second suspension rack 108B is mounted to the second carriage module 104B at an oblique angle, opposite of the other suspension rack. That is, the two suspension racks are angled away from each other, facilitating the attachment of payloads on both sides without interference.

In the above description, certain terms may be used such as “up,” “down,” “upper,”“lower,”“horizontal,”“vertical,”“left,”“right,”“over,”“under”and the like. These terms are used, where applicable, to provide some clarity of description when dealing with relative relationships. But, these terms are not intended to imply absolute relationships, positions, and/or orientations. For example, with respect to an object, an “upper”surface can become a “lower”surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/−5% of a given value, however in additional embodiments any disclosure of “about” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third”or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to”and/or as being “operative to”perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

1. A pylon assembly for an aircraft, comprising:
a core module comprising an inboard side having multiple first sets of carriage-attachment elements, each one of the first sets of carriage-attachment elements disposed at different locations along the inboard side, and an outboard side, opposite of the inboard side and having multiple second sets of carriage-attachment elements, each one of the second sets of carriage-attachment elements disposed at different locations along the outboard side;
a forward post assembly extending from a forward portion of the core module and an aft post assembly extending from an aft portion of the core module, wherein the forward post assembly and the aft post assembly are removably mountable to the aircraft;
a carriage module comprising a set of core-attachment elements corresponding to any selected one of the first sets of carriage-attachment elements or any selected one of the second sets of carriage-attachment elements, such that the carriage module is removably attachable to either one of the inboard side of the core module, via any one of the first sets of carriage-attachment elements, or the outboard side of the core module, via any one of the second sets of carriage-attachment elements; and
a suspension rack mounted to the carriage module and configured to support a payload.

2. The pylon assembly of claim 1, further comprising a second carriage module comprising a set of core-attachment elements corresponding to any selected one of the first sets of carriage-attachment elements or any selected one of the second sets of carriage-attachment elements, such that the second carriage module is removably attachable to either one of the inboard side of the core module, via any of the first sets of carriage-attachment elements, or to the outboard side of the core module, via any one of the second sets of carriage-attachment elements.

3. The pylon assembly of claim 2, wherein, when the carriage module is removably attached to either one of the inboard side of the core module or the outboard side of the core module, the second carriage module is removably attachable to the other one of the inboard side of the core module or the outboard side of the core module, such that the carriage module and the second carriage module are removably attachable to opposing sides of the core module.

4. The pylon assembly of claim 1, further comprising an upper core fairing removably attachable to a top surface of the core module and configured to interface with the aircraft.

5. The pylon assembly of claim 1, wherein:
the inboard side of the core module comprises three first sets of carriage-attachment elements;
the outboard side of the core module comprises three second sets of carriage-attachment elements; and
the carriage module is attachable to any one of the three first sets of carriage-attachment elements and the three second sets of carriage-attachment elements, such that the carriage module is attachable to the core module in any one of a forward-inboard position, a center-inboard position, an aft-inboard position, a forward-outboard position, a center-outboard position, or an aft-outboard position.

6. The pylon assembly of claim 1, wherein the core module comprises:
a central core structure;
a forward core fairing that is removably attachable to a forward end of the central core structure; and
an aft core fairing that is removably attachable to an aft end of the central core structure.

7. The pylon assembly of claim 6, wherein the forward core fairing and the aft core fairing are interchangeable, such that either one of the forward core fairing or the aft core fairing is attachable to either one of the forward end or the aft end of the core module.

8. The pylon assembly of claim 1, wherein the carriage module is symmetrical about a plane of symmetry that divides a forward portion of the carriage module from an aft portion of the carriage module.

9. The pylon assembly of claim 1, wherein the carriage module comprises:
a central carriage structure;
a first carriage fairing coupled to a forward end of the central carriage structure; and
a second carriage fairing coupled to an aft end of the central carriage structure, wherein the first carriage fairing and the second carriage fairing are mirror images of each other.

10. The pylon assembly of claim 1, wherein the suspension rack is mounted to the carriage module at an oblique angle relative to a vertical plane of the core module that divides an inboard side of the core module from an outboard side of the core module, such that, when a payload is supported by the suspension rack, the payload is angled at the oblique angle relative to the vertical plane of the core module.

11. An aircraft system, comprising:
an aircraft comprising multiple mounting hardpoint pairs; and
a pylon assembly removably mountable to any one of the multiple mounting hardpoint pairs, the pylon assembly comprising:
a core module comprising an inboard side having multiple first sets of carriage-attachment elements, each one of the first sets of carriage-attachment elements disposed at different locations along the inboard side, and an outboard side, opposite the inboard side, having multiple second sets of carriage-attachment elements, each one of the second sets of carriage-attachment elements disposed at different locations along the outboard side;
a forward post assembly extending from a forward portion of the core module and an aft post assembly extending from an aft portion of the core module, wherein the forward post assembly and the aft post assembly are removably mountable to the aircraft;
a carriage module comprising a set of core-attachment elements corresponding to any selected one of the first sets of carriage-attachment elements or any selected one of the second set of carriage-attachment elements, such that the carriage module is removably attachable to either one of the inboard side of the core module, via any one of the first sets of carriage-attachment elements, or the outboard side of the core module, via any one of the second sets of carriage-attachment elements; and
a suspension rack mounted to the carriage module and configured to support a payload;
wherein:
at least one of the multiple mounting hardpoint pairs is located on a left side of the aircraft and at least another one of the multiple mounting hardpoint pairs is located on a right side of the aircraft; and
the core module is reconfigurable for left side attachment to the at least one of the multiple mounting hardpoint pairs on the left side of the aircraft or right side attachment to the at least another one of the multiple mounting hardpoint pairs on the right side of the aircraft.

12. The aircraft system of claim 11, wherein the core module comprises at least three first sets of carriage-attachment elements and at least three second sets of carriage-attachment elements.

13. The aircraft system of claim 11, wherein the pylon assembly further comprises a second carriage module comprising a set of core-attachment elements corresponding to any selected one of the first sets of carriage-attachment elements or any selected one of the second set of carriage-attachment elements, such that the second carriage module is removably attachable to either one of the inboard side of the core module, via any of the first sets of carriage-attachment elements, or to the outboard side of the core module, via any one of the second sets of carriage-attachment elements.

14. The aircraft system of claim 11, wherein the forward post assembly and the aft post assembly are swappable with each other.

15. The aircraft system of claim 11, wherein the pylon assembly further comprises an upper core fairing removably attachable to a top surface of the core module and configured to interface an exterior surface of the aircraft;
wherein:
the upper core fairing is specific to a select one of the multiple mounting hardpoint pairs; and
when the pylon assembly is mounted to the aircraft, the upper core fairing corresponds with an outer mold line of the exterior surface of the aircraft.

16. The aircraft system of claim 11, wherein, when the pylon assembly is mounted to one of the multiple mounting hardpoint pairs, the core module is parallel to a longitudinal axis of the aircraft.

17. The aircraft system of claim 11, wherein:
the aircraft comprises at least one weapons bay with opposing doors that are openable outward toward the left side and the right side of the aircraft;
the pylon assembly is removably mountable to the aircraft adjacent to one of the opposing doors of the at least one weapons bay;
when the pylon assembly is mounted adjacent to one of the opposing doors of the at least one weapons bay, and when the carriage module is attached to the inboard side of the core module, via any one of the first sets of carriage-attachment elements, the opposing doors of the at least one weapons bay are partially openable; and
when the pylon assembly is mounted adjacent to one of the opposing doors of the at least one weapons bay, and when the carriage module is attached to the outboard side of the core module, via any one of the second sets of carriage-attachment elements, the opposing doors of the at least one weapons bay are fully openable.

18. A method of attaching a payload to an aircraft, the method comprising:
removably mounting a core module of a pylon assembly to a selected one of multiple mounting hardpoint pairs located on either a left side or a right side of an aircraft, wherein the core module is reconfigurable for left side attachment to one of the multiple mounting hardpoint pairs on the left side or right side attachment to one of the multiple mounting hardpoint pairs on the right side of the aircraft;
removably attaching a carriage module to any one of multiple sets of carriage-attachment elements disposed at different locations along the core module, wherein a suspension rack is mounted to the carriage module at an oblique angle relative to a vertical plane of the core module that divides an inboard side of the core module from an outboard side of the core module; and
removably attaching a payload to the suspension rack, wherein the payload is angled at an oblique angle relative to the vertical plane of the core module.

19. The method of claim 18, wherein:
the core module comprises the inboard side having first sets of carriage-attachment elements and the outboard side, opposite of the inboard side and having second sets of carriage-attachment elements; and
removably attaching the carriage module to any one of the multiple sets of carriage-attachment elements of the core module comprises attaching the carriage module to either one of the inboard side of the core module, via any one of the first sets of carriage-attachment elements, or the outboard side of the core module, via any one of the second sets of carriage-attachment elements.

20. The method of claim 18, further comprising:
removably attaching a second carriage module to another one of the multiple sets of carriage-attachment elements of the core module, such that the carriage module and the second carriage module are attached to opposing sides of the core module, wherein a second suspension rack is mounted to the second carriage module at an oblique angle relative to the vertical plane of the core module and wherein the suspension rack and the second suspension rack are angled away from each other; and
removably attaching a second payload to the second suspension rack, wherein the second payload is angle at an oblique angle relative to the vertical plane of the core module.
